(19) United States
(12) Patent Application Publication
(10) Pub. No.: US 2025/0181745 A1
(43) Pub. Date: Jun. 5, 2025

(54) DATA ACCESS METHOD AND SYSTEM, HARDWARE OFFLOADING DEVICE, ELECTRONIC DEVICE, AND MEDIUM

(71) Applicant: CLOUD INTELLIGENCE ASSETS HOLDING (SINGAPORE) PRIVATE LIMITED, Singapore (SG)

(72) Inventor: Jun PIAO, Hangzhou (CN)

(21) Appl. No.: 18/842,736

(22) PCT Filed: Mar. 24, 2023
(86) PCT No.: PCT/CN2023/083533

§ 371 Date: Aug. 29, 2024

(30) Foreign Application Priority Data
Mar. 25, 2022 (CN) 202210307679.3

(51) Int. Cl. G06F 21/62

(52) U.S. Cl. CPC G06F 21/6218

(57) ABSTRACT

Embodiments of the present application provide a data access method and system, a hardware offloading device, an electronic device, and a medium. In the embodiments of the present application, on one hand, a data access task for an object-based storage system is transferred from an electronic device to a hardware offloading device for execution, which can reduce processing pressure on the electronic device, improve processing performance of the electronic device, and enhance data access performance. On the other hand, after every time receiving a to-be-written file from an application, the hardware offloading device does not directly write the to-be-written file into the object-based storage system, but first caches it locally, and after a plurality of to-be-written files are cached, the hardware offloading device merges the plurality of to-be-written files into a new object file to write it into the object-based storage system.

### CROSS-REFERENCE TO RELATED APPLICATION

This application is a National Stage of International Application No. PCT/CN2023/083533, filed on Mar. 24, 2023, which claims priority to Chinese patent application No. 202210307679.3, filed with the China National Intellectual Property Administration on Mar. 25, 2022 and entitled “DATA ACCESS METHOD AND SYSTEM, HARDWARE OFFLOADING DEVICE, ELECTRONIC DEVICE, AND MEDIUM”. These applications are hereby incorporated by reference in their entireties.

### TECHNICAL FIELD

The present application relates to the field of computer technologies and, in particular, to a data access method and system, a hardware offloading device, an electronic device, and a medium.

### BACKGROUND

An object-based storage system is a storage system in the form of Key-Value (key-value pairs), which can provide object-based storage services with high persistence, high availability, and high performance. The object-based storage system uses an object file as a basic unit for storing data, and in the process of using the object-based storage system, a user needs to pay not only a storage fee for data persistence, but also a request fee for object file access. The request fee is generally charged according to the number of times of object file access, and the larger the number of times of object file access is, the higher the generated request fee is.

In some application scenarios, massive amounts of various small files with relatively small amounts of data may be generated. The various small files include, for example, but are not limited to, a text file, a picture file, an audio file, a video file, and the like. Currently, small files are each taken as an object file to be written into an object-based storage system. In this way, when massive amounts of small files are written into the object-based storage system, a relatively large number of times of object file access will be generated, which generate a relatively high request fee and a relatively high data access cost.

### SUMMARY

Multiple aspects of the present application provide a data access method and system, a hardware offloading device, an electronic device, and a medium, so as to reduce a request fee generated along with accessing object files in an object-based storage system, and reduce a data access cost.

An embodiment of the present application provides a data access method, applied to a client running on a hardware offloading device, where the hardware offloading device is communicatively connected to an electronic device through a bus. The method includes: acquiring to-be-written files sent by an application on the electronic device, and writing the to-be-written files into a cache on the hardware offloading device; if the to-be-written files cached in the cache meet a file merging condition, performing file merging on the to-be-written files cached in the cache to obtain a first object file to be written; and writing the first object file into an object-based storage system to which the client has an access permission.

An embodiment of the present application further provides a hardware offloading device, where the hardware offloading device is communicatively connected to an electronic device through a bus. The hardware offloading device includes a main processor and a cache, and the main processor runs a program of a client to: acquire to-be-written files sent by an application on the electronic device, and write the to-be-written files into the cache on the hardware offloading device; if the to-be-written files cached in the cache meet a file merging condition, perform file merging on the to-be-written files cached in the cache to obtain a first object file to be written; and write the first object file into an object-based storage system to which the client has an access permission.

An embodiment of the present application further provides an electronic device, including a processor and the hardware offloading device mentioned above, where the processor runs at least one application, and the processor is communicatively connected to the hardware offloading device through a bus.

An embodiment of the present application further provides a data access system, including: an electronic device, a hardware offloading device and an object-based storage system. The electronic device is communicatively connected to the hardware offloading device through a bus, and the hardware offloading device is communicatively connected to the object-based storage system. The electronic device runs at least one application, and is configured to send to-be-written files to the hardware offloading device through the application. The hardware offloading device is configured to: acquire the to-be-written files and write the to-be-written files into a cache on the hardware offloading device; if the to-be-written files cached in the cache meet a file merging condition, perform file merging on the to-be-written files cached in the cache to obtain a first object file to be written; and send a write request including the first object file to the object-based storage system. The object-based storage system is configured to store the first object file in response to the write request.

An embodiment of the present application further provides a computer storage medium storing a computer program, where when the computer program is executed by a processor, the processor is enabled to implement the steps in the data access method.

In the embodiments of the present application, on one hand, a data access task for the object-based storage system is transferred from the electronic device to the hardware offloading device for execution, which can reduce processing pressure on the electronic device, improve processing performance of the electronic device, and enhance data access performance. On the other hand, after every time receiving a to-be-written file from the application, the hardware offloading device does not directly write the to-be-written file into the object-based storage system, but first caches it locally, and after a plurality of to-be-written files are cached, the hardware offloading device merges the plurality of to-be-written files into a new object file to write it into the object-based storage system to which the client has the access permission. In this way, the number of times of object file access for the object-based storage system can be greatly reduced, so that a request fee generated from the object file access for the object-based storage system is reduced, and a data access cost is reduced. Especially for a scenario of massive amounts of small files, the number of times of object file access for the object-based storage system can be greatly reduced, so that the request fee generated from the object file access for the object-based storage system is reduced, and the data access cost is reduced. In addition, occurrences of a situation of a traffic rate limit in the object-based storage system triggered by a large number of data access requests are greatly reduced, enhancing storage performance and access performance of the object-based storage system.

### BRIEF DESCRIPTION OF DRAWINGS

The drawings described herein are used to provide further understanding of the present application, and constitute a part of the present application. The exemplary embodiments of the present application and the description thereof are used to explain the present application, and do not constitute improper limitations to the present application. In the drawings:

FIG. 1 is a schematic structural diagram of a data access system provided in an embodiment of the present application;

FIG. 2 is a flowchart of a data access method provided in an embodiment of the present application;

FIG. 3 is a schematic structural diagram of another data access system provided in an embodiment of the present application;

FIG. 4 is a flowchart of another data access method provided in an embodiment of the present application;

FIG. 5 is a schematic structural diagram of a hardware offloading device provided in an embodiment of the present application;

FIG. 6 is a schematic structural diagram of an electronic device provided in an embodiment of the present application.

### DESCRIPTION OF EMBODIMENTS

In order to make the objectives, technical solutions and advantages of the present application clearer, the technical solutions of the present application will be clearly and completely described below with reference to specific embodiments and corresponding drawings in the present application. Obviously, the described embodiments are only part of embodiments of the present application, rather than all embodiments. Based on the embodiments in the present application, all other embodiments obtained by those of ordinary skill in the art without making creative efforts shall fall within the protection scope of the present application.

In addition, in order to clearly describe the technical solutions of the embodiments of the present application, in the embodiments of the present application, “first”, “second” and the like are used to distinguish same or similar items with substantially same functions and effects. A person skilled in the art can understand that “first”, “second” and the like do not limit the quantity and execution order, and “first”, “second” and the like also do not limit being definitely different.

First of all, nouns involved in embodiments of the present application are explained.

A virtual filesystem (Virtual Filesystem Switch, VFS) is a kernel software layer that provides a POSIX (Portable Operating System Interface of UNIX, portable operating system interface) for an upper-layer application, so that the upper-layer application can use the interface POSIX to access different filesystems.

A filesystem in userspace (FUSE) is a software interface for a Unix-like-oriented computer operating system, which enables an unprivileged user to create his/her own filesystem without editing kernel code. The filesystem in userspace provides a kernel module and a userspace library (libfuse) module. The kernel module is responsible for encapsulating a file operation command into a file operation request of a FUSE protocol and sending it to the userspace library module through a transmission channel. The userspace library module receives and parses the file operation request of the FUSE protocol, and calls a corresponding file operation function for processing according to a FUSE-protocol data command type. For more information about the kernel module and the userspace library module in the filesystem in userspace, please refer to the related art.

A hardware offloading device refers to a hardware device with a hardware offloading (offload) function. In an embodiment of the present application, the hardware offloading device can undertake a data access task of accessing an object-based storage system that is originally performed by an electronic device running an application (App), thereby reducing processing pressure on the electronic device and improving processing performance of the electronic device.

In some application scenarios, massive amounts of various small files with relatively small amounts of data may be generated. The various small files include, for example, but are not limited to, a text file, a picture file, an audio file, a video file, and the like. Currently, small files are each taken as an object file to be written into an object-based storage system. In this way, when massive amounts of small files are written into the object-based storage system, a relatively large number of times of object file access will be generated, which generate a relatively high request fee and a relatively high data access cost. In view of the above technical problem, embodiments of the present application provide a data access method and system, a hardware offloading device, an electronic device, and a medium. In the embodiments of the present application, on one hand, a data access task for an object-based storage system is transferred from an electronic device to a hardware offloading device for execution, which can reduce processing pressure on the electronic device, improve processing performance of the electronic device, and enhance data access performance. On the other hand, after every time receiving a to-be-written file from an application, the hardware offloading device does not directly write the to-be-written file into the object-based storage system, but first caches it locally, and after a plurality of to-be-written files are cached, the hardware offloading device merges the plurality of to-be-written files into a new object file to write it into the object-based storage system to which a client has an access permission. In this way, the number of times of object file access for the object-based storage system can be greatly reduced, so that a request fee generated from the object file access for the object-based storage system is reduced, and a data access cost is reduced. Especially for a scenario of massive amounts of small files, the number of times of object file access for the object-based storage system can be greatly reduced, so that the request fee generated from the object file access for the object-based storage system is reduced, and the data access cost is reduced. In addition, occurrences of a situation of a traffic rate limit in the object-based storage system triggered by a large number of data access requests are greatly reduced, enhancing storage performance and access performance of the object-based storage system.

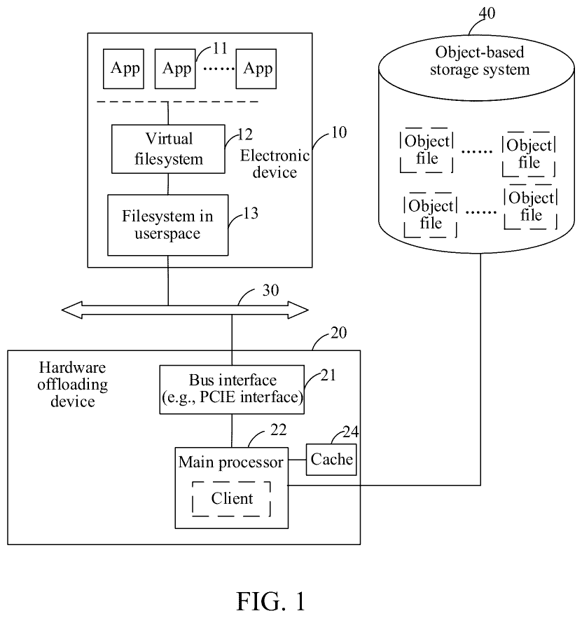

FIG. 1 is a schematic structural diagram of a data access system provided in an embodiment of the present application. Referring to FIG. 1, the system may include an electronic device 10, a hardware offloading device 20, and an object-based storage system 40. Here, the electronic device 10 and the hardware offloading device 20 are communicatively connected through a bus 30, and the hardware offloading device 20 may be in a wired or wireless communication connection with the object-based storage system 40.

Here, one or more Apps 11 may run on the electronic device 10, and when any App 11 has a data access requirement, it may call an interface POSIX provided by a virtual filesystem 12 to send a data access request, such as a write request, a read request, etc., to a filesystem in userspace 13. The filesystem in userspace 13 receives, through its kernel module, the data access request sent by the virtual filesystem 12, and sends the data access request to the hardware offloading device 20 through the bus 30.

The hardware offloading device 20 receives, through a bus interface 21, the data access request sent by the electronic device 10 through the kernel module, and sends the data access request to a main processor 22. The main processor 22 provides the data access request to a client. The client performs data interaction with the object-based storage system 40 in response to the data access request, for example, the client writes an object file into the object-based storage system 40, or reads an object file in the object-based storage system 40.

Further in an implementation, the kernel module may further convert the data access request complying with a POSIX file protocol into the data access request complying with a FUSE protocol adapted to the filesystem in userspace 13, and send the data access request of the FUSE protocol to the hardware offloading device 20 through the bus 30. Correspondingly, the bus interface 21 on the hardware offloading device 20 performs conversion on the received data access request of the FUSE protocol to obtain the data access request of the POSIX file protocol, and sends the data access request of the POSIX file protocol to the main processor 22.

Here, the bus interface 21 may be a PCIE (peripheral component interconnect express, express serial computer expansion bus standard) interface, an SPI (serial peripheral interface), or an AXI (Advanced extensible Interface).

Here, the main processor 22 includes, for example, but is not limited to, a DSP (Digital Signal Processing) unit, an NPU (Neural-network Processing Unit, embedded neural network processing unit), a CPU (central processing unit), and a GPU (Graphics Processing Unit).

In the embodiment, in an object file writing stage, the electronic device is configured to send to-be-written files to the hardware offloading device through an application. The hardware offloading device is configured to: acquire the to-be-written files and write the to-be-written files into a cache on the hardware offloading device; if the to-be-written files cached in the cache meet a file merging condition, perform file merging on the to-be-written files cached in the cache to obtain a first object file to be written; and send a write request including the first object file to the object-based storage system. The object-based storage system is configured to store the first object file in response to the write request. For more information about an interaction process of the data access system in the object file writing stage, please refer to the following text.

In the embodiment, in an object file reading stage, the electronic device is configured to send a first read request to the hardware offloading device through an application, where the first read request includes a file name of a target file to which target data to be read belongs, and first location information of the target data in the target file. The hardware offloading device receives the first read request sent by the application; sends a second read request to the object-based storage system, where the second read request includes the file name of the target file; receives the second object file returned by the object-based storage system, and acquires the target file from the second object file; and reads the target data from the target file according to the first location information, and sends the target data to the application. The object-based storage system is configured to acquire, from stored object files, the second object file including the target file in response to the second read request. For more information about an interaction process of the data access system in the object file reading stage, please refer to the following text.

In the following, technical solutions provided by the embodiments of the present application are described in detail in combination with accompanying drawings.

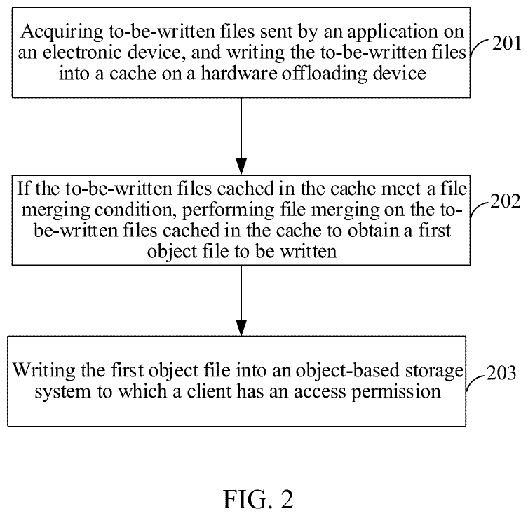

FIG. 2 is a flowchart of a data access method provided in an embodiment of the present application. The method is applied to a client running on a hardware offloading device 20, where the hardware offloading device 20 is communicatively connected to an electronic device 10 through a bus 30. As shown in FIG. 2, the method may include the following steps:
201, acquiring to-be-written files sent by an application on the electronic device 10, and writing the to-be-written files into a cache 24 on the hardware offloading device 20;
202, if the to-be-written files cached in the cache 24 meet a file merging condition, performing file merging on the to-be-written files cached in the cache 24 to obtain a first object file to be written;
203, writing the first object file into an object-based storage system 40 to which the client has an access permission.

Specifically, any application on the electronic device 10 may send a to-be-written file to the hardware offloading device 20 under a trigger of a file writing requirement. The client on the hardware offloading device 20 acquires the to-be-written file from the application, and writes the to-be-written file into the cache 24 on the hardware offloading device 20.

In an implementation, when the client acquires the to-be-written files sent by the application on the electronic device 10, the client is specifically configured to: receive write requests sent by the application through a bus interface 21, where the write requests are sent by the application through calling a kernel module provided by a filesystem in userspace 13; and process the write requests through calling a userspace library module provided by the filesystem in userspace 13 to obtain the to-be-written files.

Here, by using the userspace library module to process the write requests, the client can not only acquire the to-be-written files from the application on the electronic device 10, but also determine an SDK (Software Development Kit) that interacts with the object-based storage system 40, but it is not limited thereto.

After writing the to-be-written files into the cache 24, the client detects whether the to-be-written files cached in the cache 24 meet the file merging condition. If the file merging condition is met, the client performs the file merging on the cached several to-be-written files to obtain a new object file. For ease of understanding and distinction, the new object file obtained from merging is referred to as the first object file. After obtaining the first object file, the client writes the first object file into the object-based storage system 40 to which the client has the access permission. If the file merging condition is not met, the client does not perform the file merging operation on the to-be-written files cached in the cache 24 temporarily. Here, the client may call the SDK that interacts with the object-based storage system 40 to write the first object file into the object-based storage system 40.

The file merging condition is not limited in the embodiment. The file merging condition includes, for example, but is not limited to: the remaining cache space in the cache 24 is less than a preset cache space, or a quantity of to-be-written files in the cache 24 is greater than or equal to a preset quantity of files, or cache duration reaches a cache cycle. Here, the cache cycle is, for example, one hour, one day, or one month. It is determined that the file merging condition is met when the to-be-written files have been cached in the cache 24 for one hour, one day, or one month.

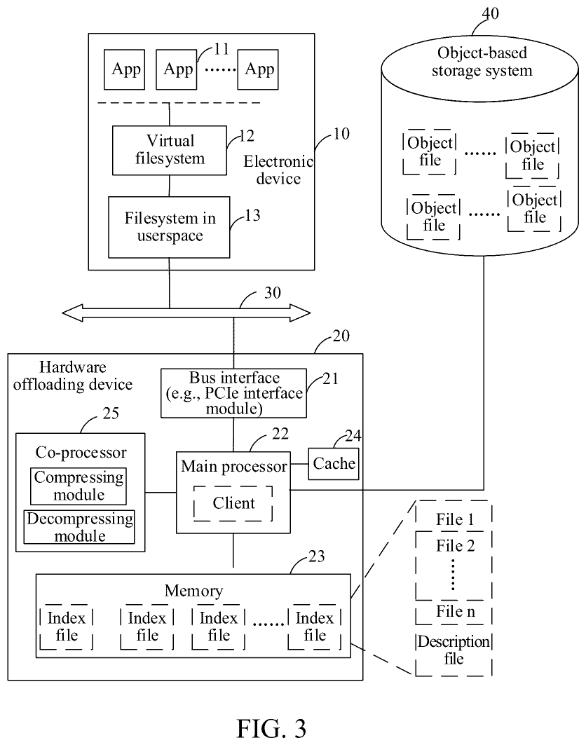

Further in an implementation, during file merging, a description file related to the first object file may be further generated. The description file may record, for example, a file name and a file size of a merged file, and location information of the merged file in the first object file. Here, file data of the merged file may be read from the first object file based on the location information of the merged file in the first object file. Referring to FIG. 3, an object file includes n merged files and one description file. Here, n is a positive integer.

For ease of understanding, an example is provided for explanation in combination with Table 1 and a scenario of massive amounts of small files.

TABLE 1

| Cost | Existing solution | Improved solution |
|---|---|---|
| Storage fee | $23 | $23 |
| Request fee | $1342 | $0.001 |

For example, a charging unit of the storage fee of the object-based storage system 40 is $0.023/GB/month, that is, 0.023 dollar needs to be paid every month for data with a data size of 1 GB. A charging unit of the request fee of the object-based storage system 40 is $0.0005c/PUT, that is, 0.0005 cents need to be paid for every time of access for each object file. Since the charging is performed according to the number of times of access for each object file, the more the number of times of access is, the higher the request fee is.

In the existing solution, small files are each taken as an object file to be written into the object-based storage system 40. For example, for a data capacity of 1 TB, 268435456 small files each with a data size of 4 KB can be stored. By calculating according to a write speed of 100 times per second, the generated storage fee for one month is about 0.023*1024=$23, and the generated request fee is 0.0005c*268435456/100=$1342. From this, it can be seen that the request fee is much greater than a data storage cost, accounting for about 98% of a total cost.

In the improved solution, a plurality of small files are merged into one object file to be written into the storage system. For example, for the data capacity of 1 TB, 205 small files each with 5 GB can be stored. The generated storage fee for one month is about 0.023*1024=$23, and the generated request fee is 0.0005c*205/100=$0.001.

Through the data access method provided in the embodiment of the present application, on one hand, a data access task for the object-based storage system 40 is transferred from the electronic device 10 to the hardware offloading device 20 for execution, which can reduce processing pressure on the electronic device 10, improve processing performance of the electronic device 10, and enhance data access performance. On the other hand, after every time receiving a to-be-written file from the application, the hardware offloading device 20 does not directly write the to-be-written file into the object-based storage system 40, but first caches it locally, and after a plurality of to-be-written files are cached, the hardware offloading device 20 merges the plurality of to-be-written files into a new object file to write it into the object-based storage system 40 to which the client has the access permission. In this way, the number of times of object file access for the object-based storage system can be greatly reduced, so that the request fee generated from the object file access for the object-based storage system is reduced, and the data access cost is reduced. Especially for the scenario of massive amounts of small files, the number of times of object file access for the object-based storage system can be greatly reduced, so that the request fee generated from the object file access for the object-based storage system is reduced, and the data access cost is reduced. In addition, occurrences of a situation of a traffic rate limit in the object-based storage system triggered by a large number of data access requests are greatly reduced, enhancing storage performance and access performance of the object-based storage system.

In some embodiments, in addition to writing the new object file into the object-based storage system 40 for storage, the client may further write the new object file into a memory 23 of the hardware offloading device 20 for storage. The new object file is stored in the memory 23 of the hardware offloading device 20 and in the object-based storage system 40, which can increase the storage security of the object file. In addition, the object file can be accessed in the memory 23 preferentially, and in a case that the memory 23 does not currently store the object file, the object file is accessed in the object-based storage system 40, which can further reduce the request fee generated along with accessing object files in the object-based storage system 40.

Thus, further in an implementation, referring to FIG. 3, the memory 23 may be provided on the hardware offloading device 20, where the memory 23, for example, includes but is not limited to: various hard disks such as a mechanical hard disk (Hard Disk Drive, HDD) and a solid state disk (SSD). Based on the above, in addition to writing the first object file into the object-based storage system 40, the client may further write the first object file into the memory 23.

Further in an implementation, the client may further write index information of the first object file into an index file, where the index information of the first object file includes an object identifier of the first object file, a storage state of the first object file, and a file name of at least one of the to-be-written files merged in the first object file. The storage state indicates whether the first object file is stored in the memory 23 or in the object-based storage system 40. Further in an implementation, the index file may be saved in the memory 23 on the hardware offloading device 20.

It should be noted that the data capacity of the memory 23 provided on the hardware offloading device 20 is smaller than that of the object-based storage system 40 which can store massive amounts of data. As time passes, some object files written into the memory 23 within a historical time period may have been cleared from the memory 23, and some may still remain in the memory 23.

Therefore, through the index information of the first object file recorded in the index file, the client can accurately know whether the memory 23 or the object-based storage system 40 saves the first object file, and quickly determine whether to perform data access to the memory 23 or to the object-based storage system 40, thereby increasing data access efficiency and reducing access frequency to the object-based storage system 40.

In an actual application, the client may directly perform the file merging on the to-be-written files cached in the cache to obtain the first object file to be written. Further in an implementation, in order to reduce resources to be consumed by data transmission and enhance data access performance, a compressing module having a data compression function may be further provided on the hardware offloading device 20. Therefore, when the client performs the file merging on the to-be-written files cached in the cache to obtain the first object file to be written, the client is specifically configured to: send the cached to-be-written files to the compressing module, to enable the compressing module to perform compression processing on the cached to-be-written files to obtain the first object file; and receive the first object file returned by the compressing module.

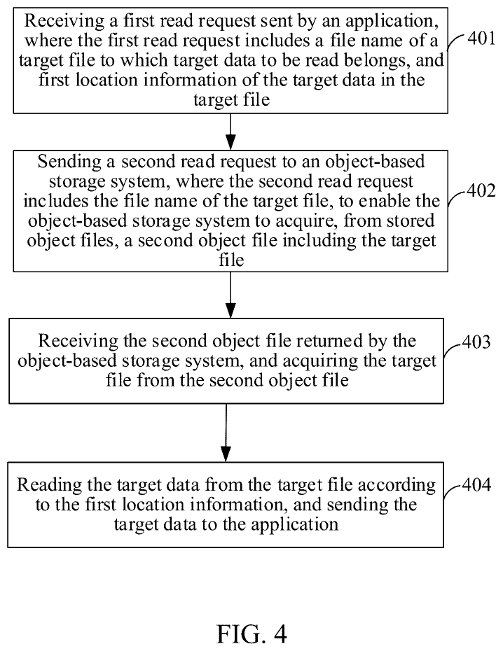

In the following, a data access method provided in an embodiment of the present application is illustrated from a data reading perspective in combination with FIG. 4. FIG. 4 is a flowchart of a data access method provided in an embodiment of the present application. The method is applied to a client running on a hardware offloading device 20, where the hardware offloading device 20 is communicatively connected to an electronic device 10 through a bus. As shown in FIG. 4, the method may include the following steps:
401, receiving a first read request sent by an application, where the first read request includes a file name of a target file to which target data to be read belongs, and first location information of the target data in the target file;
402, sending a second read request to an object-based storage system 40, where the second read request includes the file name of the target file, to enable the object-based storage system 40 to acquire, from stored object files, a second object file including the target file;
403, receiving the second object file returned by the object-based storage system 40, and acquiring the target file from the second object file;
404, reading the target data from the target file according to the first location information, and sending the target data to the application.

In the embodiment, any application on the electronic device 10 may send the first read request to the hardware offloading device 20 under a trigger of a file reading requirement, where the first read request includes the file name of the target file to which the target data to be read belongs, and the first location information of the target data in the target file. Here, the first location information is a writing location of the target data in the target file, and the target data can be read from the target file according to the first location information.

The client calls an SDK that interacts with the object-based storage system 40 to send the second read request to the object-based storage system 40. In response to the second read request, the object-based storage system 40 makes a query in pre-saved metadata according to the file name of the target file in the second read request, determines an object name of the second object file including the target file, and acquires, according to the object name of the second object file, the second object file from the stored object files to return it to the client.

In an actual application, the second object file may be not subject to data compression. In this case, location information of the target file in the second object file may be directly acquired from a description file corresponding to the second object file. For ease of understanding and distinction, the location information of the target file in the second object file is referred to as second location information. The target file is acquired from the second object file according to the second location information. The second object file may have been subject to data compression. In this case, the second object file needs to be decompressed, and the target file is acquired from a decompressed second object file. In an implementation, a decompressing module having a data decompression function may be provided on the hardware offloading device 20. Then, when the client acquires the target file from the second object file, the client is specifically configured to: send the second object file to the decompressing module, to enable the decompressing module to perform decompression processing on the second object file to obtain a decompressed second object file; receive the decompressed second object file returned by the decompressing module, and make a query in a description file corresponding to the decompressed second object file according to the file name of the target file, to obtain second location information of the target file in the decompressed second object file; and acquire the target file from the decompressed second object file according to the second location information.

In an actual application, after receiving the first read request sent by the application, the client may directly access the object-based storage system 40 to acquire the second object file including the target file. The client may also first access a memory 23 on the hardware offloading device 20, and then access the object-based storage system 40 after not acquiring the second object file from the memory 23. Further in an implementation, in order to increase data access efficiency and reduce the number of times of access to the object-based storage system 40, before sending the second read request to the object-based storage system 40, the client may further make a query in the index file according to the file name of the target file to acquire a storage state of the second object file, and then perform the step of sending the second read request to the object-based storage system 40 if the storage state of the second object file indicates that the second object file is stored only in the object-based storage system 40. If the storage state of the second object file indicates that the second object file is stored in the memory 23, the second object file is acquired from the memory 23.

It should be noted that the object file is accessed in the memory 23 preferentially, and in a case that the memory 23 does not currently store the object file, the object file is accessed in the object-based storage system 40, which can further reduce a request fee generated along with accessing object files in the object-based storage system 40.

Through the data access method provided in the embodiment of the present application, on one hand, a data access task for the object-based storage system is transferred from the electronic device to the hardware offloading device for execution, which can reduce processing pressure on the electronic device, and enhance data access performance. On the other hand, in a case that the data to be read is file data in a plurality of files included in a same object file, when the data in the plurality of files in the same object file needs to be read, it is only necessary to access the same object file in the object-based storage system once, and there is no need to access a plurality of object files in the object-based storage system multiple times. Thereby, the number of times of object file access for the object-based storage system can be greatly reduced, so that a request fee generated from the object file access for the object-based storage system is reduced, and a data access cost is reduced. Especially for a scenario of massive amounts of small files, the number of times of object file access for the object-based storage system can be greatly reduced, so that the request fee generated from the object file access for the object-based storage system is reduced, and the data access cost is reduced. In addition, occurrences of a situation of a traffic rate limit in the object-based storage system triggered by a large number of data access requests are greatly reduced, enhancing storage performance and access performance of the object-based storage system.

It should be noted that, for the hardware offloading device 20, the client, the compressing module and the decompressing module may run on a single processor, or the client, the compressing module and the decompressing module may run on a plurality of processors. Referring to FIG. 3, the hardware offloading device 20 is provided with a main processor 22 and a co-processor 25. Here, the main processor 22 and the co-processor 25 include, for example, but are not limited to, a DSP (Digital Signal Processing) unit, an NPU (Neural-network Processing Unit, embedded neural-network processing unit), a CPU (central processing unit), and a GPU (Graphics Processing Unit). The client runs on the main processor 22, and the compressing module and the decompressing module are provided on the co-processor 25. The main processor 22 and the co-processor 25 work together in collaboration, which can improve overall data access performance.

It should be noted that, executive entities of the steps of the method provided in the foregoing embodiments may be the same one device, or different devices may also be taken as the executive entities of the method. For example, an executive entity for step 201 to step 203 may be device A; for another example, an executive entity for steps 201 and 202 may be device A, and an executive entity for step 203 may be device B; and the like.

In addition, in some processes described in the foregoing embodiments and accompanying drawings, a plurality of operations occurring in a specific order are included, but it should be clearly understood that these operations may not be executed in the order appeared herein or may be executed in parallel. The serial numbers of the operations, such as 201, 202 and others, are merely used to distinguish different operations, and the serial numbers themselves do not represent any execution order. In addition, these processes may include more or fewer operations, and these operations may be executed sequentially or executed in parallel. It should be noted that descriptions such as “first” and “second” herein are used to distinguish different messages, devices, modules, etc., and do not represent an order. In addition, “first” and “second” are not limited to be different types.

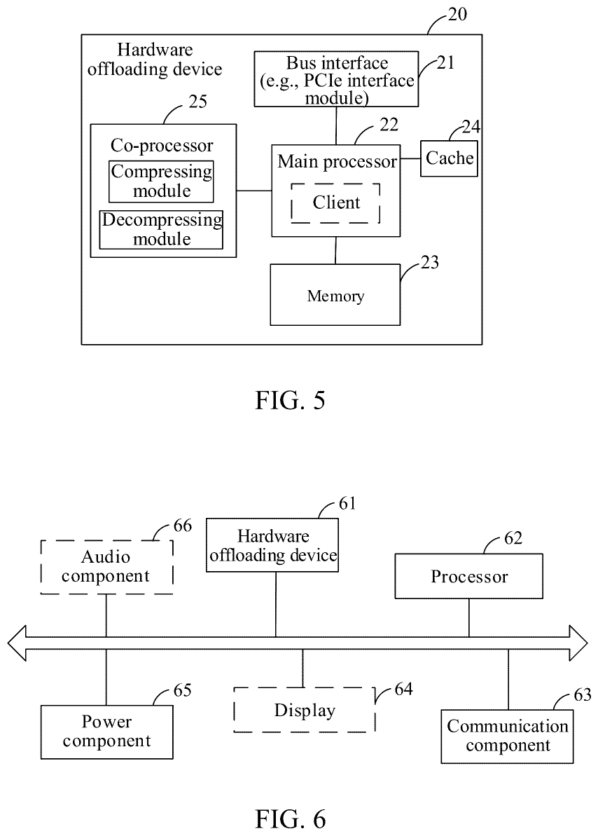

FIG. 5 is a schematic structural diagram of a hardware offloading device 20 provided in an embodiment of the present application. The hardware offloading device 20 is communicatively connected to an electronic device 10 through a bus. As shown in FIG. 5, the hardware offloading device 20 includes a main processor 22 and a cache, where the main processor 22 runs a program of a client to: acquire to-be-written files sent by an application on the electronic device 10, and write the to-be-written files into the cache 24 on the hardware offloading device 20; if the to-be-written files cached in the cache 24 meet a file merging condition, perform file merging on the to-be-written files cached in the cache 24 to obtain a first object file to be written; and write the first object file into an object-based storage system 40 to which the client has an access permission.

Further in an implementation, the hardware offloading device 20 further includes a memory 23. The main processor 22 is further configured to: write the first object file into the memory 23, and write index information of the first object file into an index file, where the index information of the first object file includes an object identifier of the first object file, a storage state of the first object file, and a file name of at least one of the to-be-written files merged in the first object file, where the storage state indicates whether the first object file is stored in the memory 23 or in the object-based storage system 40.

Further in an implementation, the hardware offloading device 20 further includes a co-processor 25. When performing the file merging, the main processor 22 is specifically configured to: send the cached to-be-written files to the co-processor 25, and receive the first object file sent by the co-processor 25. The co-processor 25 is configured to: perform compression processing on the cached to-be-written files to obtain the first object file, and send the first object file to the main processor 22.

Further in an implementation, the main processor 22 is further configured to: receive a first read request sent by the application, where the first read request includes a file name of a target file to which target data to be read belongs, and first location information of the target data in the target file; send a second read request to the object-based storage system 40, where the second read request includes the file name of the target file, to enable the object-based storage system 40 to acquire, from stored object files, a second object file including the target file; receive the second object file returned by the object-based storage system 40, and acquire the target file from the second object file; and read the target data from the target file according to the first location information, and send the target data to the application.

Further in an implementation, when acquiring the target file, the main processor 22 is specifically configured to: send the second object file to the co-processor 25, receive the decompressed second object file returned by the co-processor 25, and make a query in a description file corresponding to the decompressed second object file according to the file name of the target file, to obtain second location information of the target file in the decompressed second object file; and acquire the target file from the decompressed second object file according to the second location information. The co-processor 25 is further configured to: perform decompression processing on the second object file to obtain the decompressed second object file, and return the decompressed second object file to the main processor 22.

Specific manners of the modules and/or units in the hardware offloading device 20 shown in FIG. 5 performing operations have been described in detail in the embodiments related to the data access method, and will not be described in detail here.

FIG. 6 is a schematic structural diagram of an electronic device provided in an embodiment of the present application. Referring to FIG. 6, the electronic device includes: a processor 62, and a hardware offloading device 61 according to any one of the foregoing embodiments, where the processor 62 runs at least one application, and the processor 62 is communicatively connected to the hardware offloading device 61 through a bus. It should be noted that the application on the processor 62 may interact with the hardware offloading device 61 to enable access to an object-based storage system. The hardware offloading device 61 receives a data access request sent from the application on the processor 62, and executes the data access method provided in the embodiments of the present application to respond to the data access request. Here, the processor 62 includes, for example, but is not limited to, a DSP (Digital Signal Processing) unit, an NPU (Neural-network Processing Unit, embedded neural-network processing unit), a CPU (central processing unit), and a GPU (Graphics Processing Unit).

Further, as shown in FIG. 6, the electronic device further includes a communication component 63, a display 64, a power component 65, an audio component 66 and other components. Only some components are schematically given in FIG. 6, which does not mean that the electronic device only includes the components shown in FIG. 6. In addition, components in dashed-line boxes in FIG. 6 are optional components, rather than mandatory components, which may specifically be provided depending on the product form of the electronic device. The electronic device in the embodiment may be implemented as a terminal device such as a desktop computer, a notebook computer, a smart phone or an IoT (Internet of Things) device, or may be a server-side device such as a regular server, a cloud server or a server array. If the electronic device in the embodiment is implemented as a terminal device such as a desktop computer, a notebook computer or a smart phone, the components in the dashed-line boxes in FIG. 6 may be included; if the electronic device in the embodiment is implemented as a server-side device such as a regular server, a cloud server or a server array; the components in the dashed-line boxes in FIG. 6 may not be included.

Correspondingly, an embodiment of the present application further provides a computer-readable storage medium in which a computer program is stored, and when the computer program is executed, the steps in the foregoing data access method can be implemented.

Correspondingly, an embodiment of the present application further provides a computer program product, including a computer program/instructions, and when the computer program/instructions is/are executed by a processor, the processor is enabled to implement the steps in the foregoing data access method.

The above communication component is configured to facilitate wired or wireless communication between a device where the communication component is located and other devices. The device where the communication component is located may access a wireless network based on a communication standard, such as WiFi, a mobile communication network like 2G (2nd Generation), 3G (3rd Generation), 4G (4th Generation)/LTE (Long Term Evolution), or 5G (5th Generation), or a combination thereof. In an exemplary embodiment, the communication component receives a broadcast signal or broadcast related information from an external broadcast management system via a broadcast channel. In an exemplary embodiment, the communication component further includes a near field communication (NFC) module to facilitate short-range communication. For example, the NFC module may be implemented based on radio frequency identification (RFID) technology, infrared data association (IrDA) technology, ultra wideband (UWB) technology, Bluetooth (BT) technology, and other technologies.

The above display includes a screen, where the screen may include a liquid crystal display (LCD) and a touch panel (TP). If the screen includes a touch panel, the screen may be implemented as a touch screen to receive an input signal from a user. The touch panel includes one or more touch sensors to sense a touch, a swipe, and a gesture on the touch panel. The touch sensor may not only sense a boundary of a touch or swipe action, but also detect a duration and a pressure related to the touch or swipe operation.

The above power component provides power to various components of a device where the power component is located. The power component may include a power management system, one or more power supplies, and other components associated with generating, managing, and distributing power for the device where the power component is located.

The above audio component may be configured to output and/or input an audio signal. For example, the audio component includes a microphone (MIC), and when a device where the audio component is located is in an operation mode, such as a call mode, a recording mode, and a voice recognition mode, the microphone is configured to receive an external audio signal. The received audio signal may be further stored in a memory 23 or transmitted via the communication component. In some embodiments, the audio component further includes a speaker for outputting an audio signal.

A person skilled in the art should understand that the embodiments of the present application may be provided as a method, a system, or a computer program product. Therefore, the present application may take a form of an entire-hardware embodiment, an entire-software embodiment, or an embodiment combining software and hardware aspects. Moreover, the present application may take a form of a computer program product implemented on one or more computer-usable storage media (including but not limited to a disk memory, a CD-ROM (Compact Disc Read-Only Memory), an optical memory, etc.) that include computer-usable program code.

The present application is described with reference to flowcharts and/or block diagrams of methods, devices (systems), and computer program products according to the embodiments of the present application. It should be understood that each process and/or block in the flowcharts and/or block diagrams and combinations of processes and/or blocks in the flowcharts and/or block diagrams may be implemented by computer program instructions. These computer program instructions may be provided to a processor of a general-purpose computer, a dedicated computer, an embedded processor, or other programmable data processing devices to generate a machine, so that instructions executed by the processor of the computer or other programmable data processing devices generate an apparatus for implementing functions specified in one or more processes of the flowcharts and/or one or more blocks of the block diagrams.

These computer program instructions may also be stored in a computer-readable memory that can guide a computer or other programmable data processing devices to work in a specific manner, so that the instructions stored in the computer-readable memory generate a manufactured product including an instruction apparatus, where the instruction apparatus implements functions specified in one or more processes of the flowcharts and/or one or more blocks of the block diagrams.

These computer program instructions may also be loaded onto a computer or other programmable data processing devices, so that a series of operation steps are performed on the computer or other programmable devices to generate computer-implemented processing, and thus the instructions executed on the computer or other programmable devices provide steps for implementing functions specified in one or more processes of the flowcharts and/or one or more blocks of the block diagrams.

In a typical configuration, an electronic device includes one or more processors (CPUs), input/output interfaces, network interfaces, and memories.

The memory may include a non-permanent memory, e.g., a random access memory (RAM), and/or a non-volatile memory, e.g., a read-only memory (ROM) or a flash memory (flash RAM), and/or other forms in a computer-readable medium. The memory is an example of the computer-readable medium.

The computer-readable media include permanent and non-permanent, removable and non-removable media in which information storage may be implemented by any method or technology. The information may be computer-readable instructions, data structures, modules of a program, or other data. Examples of the computer storage media include, but are not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disc read-only memory (CD-ROM), a digital versatile disc (DVD) or other optical storage, a magnetic cassette tape, a tape disk storage or other magnetic storage devices or any of other non-transmission media that can be used to store information that can be accessed by an electronic device. As defined herein, the computer-readable media do not include transitory computer-readable media (transitory media), e.g., a modulated data signal and a carrier wave.

It should also be noted that terms “include”, “comprise” or any other variant thereof are intended to cover non-exclusive inclusion, so that a process, method, commodity or device that includes a series of elements not only includes those elements, but also includes other elements that are not explicitly listed, or further includes elements inherent to the process, method, commodity or device. In the absence of more restrictions, the element defined by the sentence “including a . . . ” does not exclude the existence of other identical elements in the process, method, commodity or device that includes the element.

The foregoing are merely embodiments of the present application, and are not intended to limit the present application. For those skilled in the art, the present application can have various modifications and changes. Any modification, equivalent replacement, improvement and the like made within the spirit and principle of the present application shall be included within the scope of the claims of the present application.

1. A data access method, applied to a client running on a hardware offloading device, wherein the hardware offloading device is communicatively connected to an electronic device through a bus, and the method comprises:
acquiring to-be-written files sent by an application on the electronic device, and writing the to-be-written files into a cache on the hardware offloading device;
if the to-be-written files cached in the cache meet a file merging condition, performing file merging on the to-be-written files cached in the cache to obtain a first object file to be written;
writing the first object file into an object-based storage system to which the client has an access permission.

2. The method according to claim 1, wherein the hardware offloading device further comprises a memory, and the method further comprises:
writing the first object file into the memory, and writing index information of the first object file into an index file, wherein the index information of the first object file comprises an object identifier of the first object file, a storage state of the first object file, and file names of the to-be-written files merged in the first object file, wherein the storage state indicates whether the first object file is stored in the memory and/or in the object-based storage system.

3. The method according to claim 1, wherein the hardware offloading device further comprises a compressing module, and performing the file merging on the to-be-written files cached in the cache to obtain the first object file to be written comprises:
sending the cached to-be-written files to the compressing module, to enable the compressing module to perform compression processing on the cached to-be-written files to obtain the first object file;
receiving the first object file returned by the compressing module.

4. The method according to claim 1, wherein acquiring the to-be-written files sent by the application on the electronic device comprises:
receiving write requests sent by the application through a bus interface, wherein the write requests are sent by the application through calling a kernel module provided by a filesystem in userspace;
processing the write requests through calling a userspace library module provided by the filesystem in userspace to obtain the to-be-written files.

5. The method according to claim 2, further comprising:
receiving a first read request sent by an application, wherein the first read request comprises a file name of a target file to which target data to be read belongs, and first location information of the target data in the target file;
sending a second read request to the object-based storage system, wherein the second read request comprises the file name of the target file, to enable the object-based storage system to acquire, from stored object files, a second object file comprising the target file;
receiving the second object file returned by the object-based storage system, and acquiring the target file from the second object file;
reading the target data from the target file according to the first location information, and sending the target data to the application which sends the first read request.

6. The method according to claim 5, wherein before sending the second read request to the object-based storage system, the method further comprises:
making a query in the index file according to the file name of the target file to acquire a storage state of the second object file;
if the storage state of the second object file indicates that the second object file is stored only in the object-based storage system, performing the step of sending the second read request to the object-based storage system.

7. The method according to claim 6, further comprising:
if the storage state of the second object file indicates that the second object file is stored in the memory, acquiring the second object file from the memory.

8. The method according to claim 5, wherein the hardware offloading device further comprises a decompressing module, and acquiring the target file from the second object file comprises:
sending the second object file to the decompressing module, to enable the decompressing module to perform decompression processing on the second object file to obtain a decompressed second object file;
receiving the decompressed second object file returned by the decompressing module, and making a query in a description file corresponding to the decompressed second object file according to the file name of the target file to obtain second location information of the target file in the decompressed second object file;
acquiring the target file from the decompressed second object file according to the second location information.

9. A hardware offloading device, wherein the hardware offloading device is communicatively connected to an electronic device through a bus, and the hardware offloading device comprises a main processor and a cache, wherein the main processor runs a program of a client to:
acquire to-be-written files sent by an application on the electronic device, and write the to-be-written files into the cache on the hardware offloading device;
if the to-be-written files cached in the cache meet a file merging condition, perform file merging on the to-be-written files cached in the cache to obtain a first object file to be written;
write the first object file into an object-based storage system to which the client has an access permission.

10. The hardware offloading device according to claim 9, further comprising a memory; wherein
the main processor is further configured to: write the first object file into the memory, and write index information of the first object file into an index file, wherein the index information of the first object file comprises an object identifier of the first object file, a storage state of the first object file, and file names of the to-be-written files merged in the first object file, wherein the storage state indicates whether the first object file is stored in the memory and/or in the object-based storage system.

11. The hardware offloading device according to claim 9, wherein the hardware offloading device further comprises a co-processor;
when performing the file merging, the main processor is specifically configured to: send the cached to-be-written files to the co-processor, and receive the first object file sent by the co-processor;
the co-processor is configured to: perform compression processing on the cached to-be-written files to obtain the first object file, and send the first object file to the main processor.

12. An electronic device, comprising: a processor and the hardware offloading device according to claim 9, wherein the processor runs at least one application, and the processor is communicatively connected to the hardware offloading device through a bus.

13. A data access system, comprising: an electronic device, a hardware offloading device and an object-based storage system; wherein the electronic device is communicatively connected to the hardware offloading device through a bus, and the hardware offloading device is communicatively connected to the object-based storage system;
the electronic device runs at least one application, and is configured to send to-be-written files to the hardware offloading device through the application;
the hardware offloading device is configured to: acquire the to-be-written files and write the to-be-written files into a cache on the hardware offloading device; if the to-be-written files cached in the cache meet a file merging condition, perform file merging on the to-be-written files cached in the cache to obtain a first object file to be written; and send a write request comprising the first object file to the object-based storage system;
the object-based storage system is configured to store the first object file in response to the write request.

14. A non-transitory computer storage medium storing a computer program, wherein when the computer program is executed by a processor, the processor is enabled to implement the steps in the method according to claim 1.

15. The hardware offloading device according to claim 10, wherein the main processor is further configured to:
receive a first read request sent by an application, wherein the first read request comprises a file name of a target file to which target data to be read belongs, and first location information of the target data in the target file;
send a second read request to the object-based storage system, wherein the second read request comprises the file name of the target file, to enable the object-based storage system to acquire, from stored object files, a second object file comprising the target file;
receive the second object file returned by the object-based storage system, and acquire the target file from the second object file;
read the target data from the target file according to the first location information, and send the target data to the application which sends the first read request.

16. The hardware offloading device according to claim 15, wherein the main processor is further configured to, before sending the second read request to the object-based storage system:
make a query in the index file according to the file name of the target file to acquire a storage state of the second object file;
if the storage state of the second object file indicates that the second object file is stored only in the object-based storage system, perform sending the second read request to the object-based storage system.

17. The electronic device according to claim 12, wherein the hardware offloading device further comprises a memory; wherein
the main processor is further configured to: write the first object file into the memory, and write index information of the first object file into an index file, wherein the index information of the first object file comprises an object identifier of the first object file, a storage state of the first object file, and file names of the to-be-written files merged in the first object file, wherein the storage state indicates whether the first object file is stored in the memory and/or in the object-based storage system.

18. The electronic device according to claim 12, wherein the hardware offloading device further comprises a co-processor;
when performing the file merging, the main processor is specifically configured to: send the cached to-be-written files to the co-processor, and receive the first object file sent by the co-processor;
the co-processor is configured to: perform compression processing on the cached to-be-written files to obtain the first object file, and send the first object file to the main processor.

19. The non-transitory computer storage medium according to claim 14, wherein the hardware offloading device further comprises a memory, and the processor is further enabled to implement:
writing the first object file into the memory, and writing index information of the first object file into an index file, wherein the index information of the first object file comprises an object identifier of the first object file, a storage state of the first object file, and file names of the to-be-written files merged in the first object file, wherein the storage state indicates whether the first object file is stored in the memory and/or in the object-based storage system.

20. The non-transitory computer storage medium according to claim 14, wherein the hardware offloading device further comprises a compressing module, and performing the file merging on the to-be-written files cached in the cache to obtain the first object file to be written comprises:
sending the cached to-be-written files to the compressing module, to enable the compressing module to perform compression processing on the cached to-be-written files to obtain the first object file;
receiving the first object file returned by the compressing module.
